(19) United States
(12) Patent Application Publication
(10) Pub. No.: US 2026/0135956 A1
(43) Pub. Date: May 14, 2026

(54) IMAGE FORMING APPARATUS

(71) Applicant: SHARP KABUSHIKI KAISHA, Sakai City (JP)

(72) Inventor: Sungi KIM, Sakai City (JP)

(21) Appl. No.: 19/358,725

(22) Filed: Oct. 15, 2025

(30) Foreign Application Priority Data
Nov. 13, 2024 (JP) 2024-198089

(51) Int. Cl. H04N 1/00

(52) U.S. Cl. CPC H04N 1/0049; H04N 1/00891; H04N 2201/0094

(57) ABSTRACT

An image forming apparatus includes: an image former; an output tray; an operation panel; a power button; and a housing. The operation panel includes: a touch panel, and a notification lamp, the notification lamp has a laterally long shape, and is disposed along a lower-side side of the touch panel at a lower portion of the operation panel, and the power button is disposed in a housing front surface upper portion on a lower side Z of the output tray and at a position overlapping in an up-down direction Z a range of the notification lamp in a left-right direction X, the housing front surface upper portion being located on an upper side Z1 of a midpoint in the up-down direction in a housing front surface portion located on a front surface side of the housing.

### DESCRIPTION

### FIELD OF THE INVENTION

The present disclosure relates to an image forming apparatus such as a copier, a multifunctional apparatus, a printer, and a facsimile machine apparatus.

### BACKGROUND ART

In the related art, in relatively compact, small-sized image forming apparatuses, interfaces such as an operation panel that receives an input from the user, a power switch, and a USB port are often disposed at various positions due to reasons such as the relationship with the internal structures and space limitations. In addition, when various interfaces are disposed at various positions, it is difficult for the user to visually recognize them at a glance and determine the state of the apparatus and the like. In addition, when the power button, the USB port, and the like are located at positions separated from the operation panel, it is difficult for the user to determine the ON/OFF of the power source and the insertion state of the USB memory at a glance when performing the input operation on the operation panel.

To solve the above-described problems, in the related art, an image forming apparatus is known in which the position where an external device for short-range wireless communication is placed and a USB port can be both easily visually recognized. Such a known image forming apparatus includes a mark (NFC mark 71) indicating the position where the external device for short-range wireless communication is placed, a USB port, and a power switch.

In the known image forming apparatus, the NFC mark of the short-range wireless communication and the USB port are not covered with an ejected sheet, and thus the visibility of the NFC mark and the USB port is ensured at all times. In addition, in the known image forming apparatus, the NFC mark and the USB port are disposed on the same side in the width direction, and the user can confirm both the NFC mark and the USB port only by confirming the same direction, and thus can easily visually recognize both the position where the external device for a short-range wireless communication is placed and the USB port.

### SUMMARY

### Technical Problem

In the known image forming apparatus, however, the power switch and the operation panel are separated from each other, and as such, the movement of the line of sight is large when the user visually recognizes the power switch and the operation panel for turning ON the power source. Therefore, in the image forming apparatus disclosed in PTL 1, it is difficult to simultaneously visually recognize the power switch and the operation panel when turning ON the power switch, and recognize the state during the turning ON of the power source, such as whether the apparatus has been normally activated.

In view of this, an object of the present disclosure is to provide an image forming apparatus that can easily determine the apparatus state during the turning ON of the power source.

### Solution to Problem

To solve the above-described objects, an image forming apparatus according to the present disclosure includes: an image former that forms an image; an output tray on which a sheet ejected toward a front side is placed; an operation panel provided above the output tray; a power button that receives an inputting operation of turning ON/OFF of a power source of the apparatus; and a housing that houses the image former. The operation panel includes: a touch panel that receives an operation for the apparatus, and a notification lamp that provides a notification of a state of the apparatus, the notification lamp has a laterally long shape, and is disposed on a lower side of the touch panel in the operation panel, and the power button is disposed on the lower side of the output tray in a housing front surface upper portion at a position overlapping in an up-down direction a range of the notification lamp in a left-right direction, the housing front surface upper portion being located on an upper side of a front surface vertical midpoint, which is a midpoint in the up-down direction in a housing front surface portion located on a front surface side of the housing.

### Advantageous Effects of Disclosure

According to the image forming apparatus of the present disclosure, the power button is disposed on the lower side of the position where the operation panel including the touch panel and the notification lamp is disposed, and thus when the operation panel is operated, both the notification lamp and the power button are easily within the field of view of the user, which makes it easy to determine the apparatus state.

### BRIEF DESCRIPTION OF THE DRAWINGS

FIG. 1 is a perspective view of an image forming apparatus according to an embodiment of the present disclosure.

FIG. 2 is a schematic view illustrating an interior of the image forming apparatus of FIG. 1.

FIG. 3 is a front view of the image forming apparatus of FIG. 1.

FIG. 4 is a front view of an operation panel provided in the image forming apparatus of FIG. 1.

### DESCRIPTION OF EMBODIMENTS

An image forming apparatus 1 according to an embodiment of the present disclosure is described below with reference to the drawings. In the following description, the same components are denoted by the same reference numerals. Their names and functions are also the same. Accordingly, detailed descriptions thereof will not be repeated.

Image Forming Apparatus

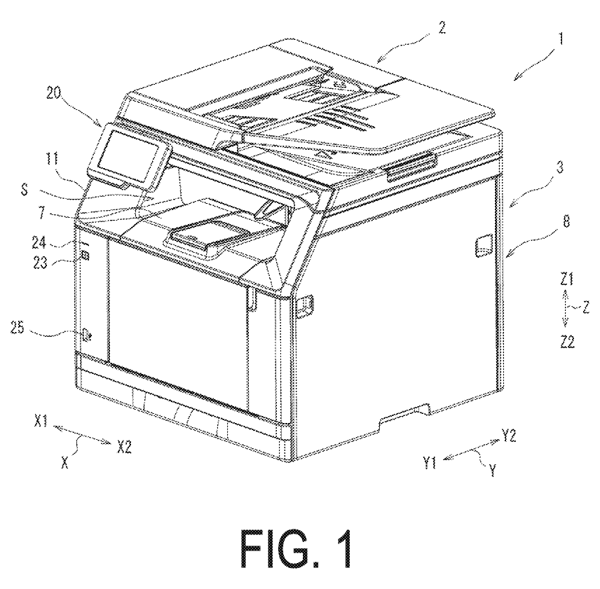

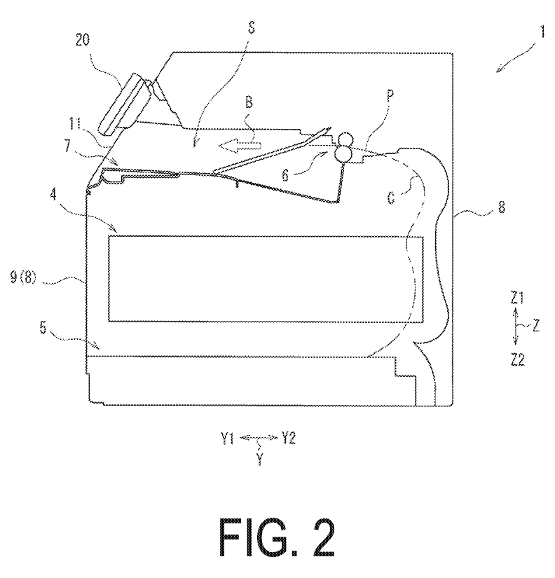

FIG. 1 is a perspective view illustrating the image forming apparatus 1 according to the present embodiment. FIG. 2 is a schematic side view illustrating an interior of the image forming apparatus 1.

The image forming apparatus 1 is a multifunctional apparatus having a copy function, a scanner function, a facsimile machine function, and a printer function. As illustrated in FIG. 1, the image forming apparatus 1 includes a document feeding device 2 and an apparatus main body 3.

In this specification, the left-right direction (the width direction of the image forming apparatus 1) in the state where the image forming apparatus 1 is installed is referred to as "left-right direction X". In addition, the left side in the left-right direction X is referred to as "left side X1" and the right side is referred to as "right side X2". In this specification, the front-rear direction in the state where the image forming apparatus 1 is installed is referred to as "front-rear direction Y". In addition, the front side in the front-rear direction Y is referred to as "front side Y1", and the rear side is referred to as "rear side Y2". In this specification, the up-down direction in the state where the image forming apparatus 1 is installed is referred to as "up-down direction Z". In addition, the upper side in the up-down direction Z is referred to as "upper side Z1", and the lower side is referred to as "lower side Z2".

The image forming apparatus 1 transmits a document image read by an image reader (not illustrated in the drawing) to outside. In addition, the image forming apparatus 1 forms the document image read by the image reader or an externally received image on a sheet P such as a recording sheet in color or monochrome. The image forming apparatus 1 may be a monochrome image forming apparatus. In addition, the image forming apparatus 1 may be a color image forming apparatus of another type.

As illustrated in FIG. 2, the apparatus main body 3 includes an image former 4, a sheet feed cassette 5, and a housing 8. In addition, although not illustrated in the drawing, the image forming apparatus 1 includes an image reader, an optical scanning device, an intermediate transfer belt device, a secondary transfer device, a fixing device, and the like. The image forming apparatus 1 houses the image former 4, the sheet feed cassette 5 and the like inside the housing 8.

In addition, as illustrated in FIG. 2, in the housing 8 of the image forming apparatus 1, a sheet conveying path C is formed. An image is formed by the image former 4 on the sheet P supplied from the sheet feed cassette 5, and the sheet is conveyed on the sheet conveying path C via the fixing device and the like, and ejected to an output tray 7 from an ejection port 6.

### Embodiments

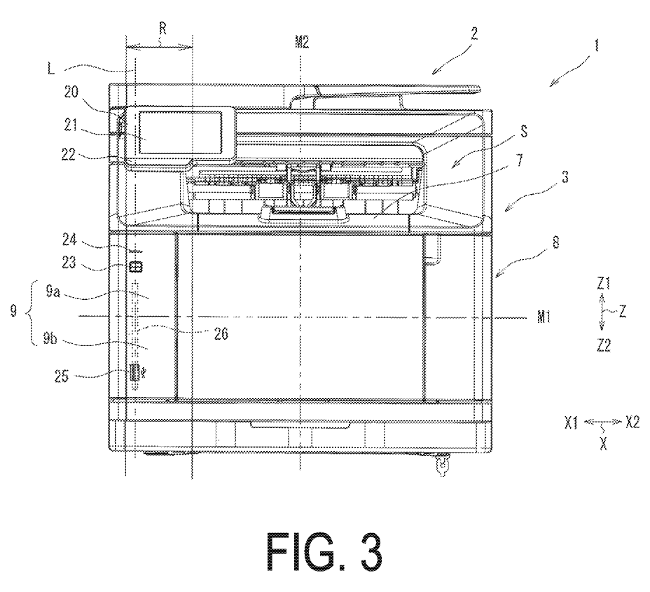

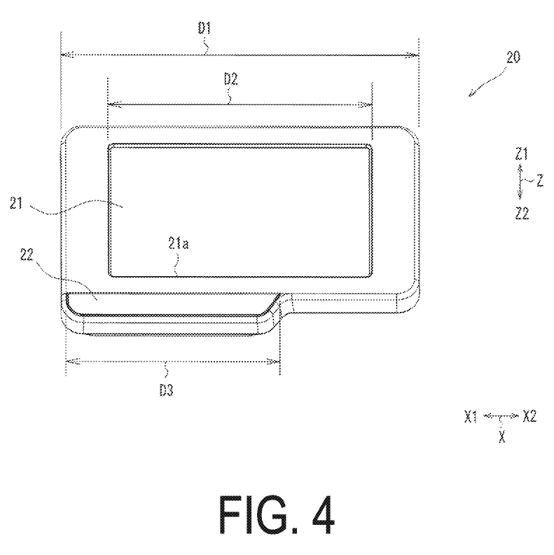

Next, an embodiment of the present disclosure is described. FIG. 3 is a front view of the image forming apparatus 1 according to the present embodiment, and FIG. 4 is a front view illustrating an operation panel 20 provided in the image forming apparatus 1.

As described above, the image forming apparatus 1 includes the image former 4 and the housing 8. In addition, as illustrated in FIG. 3, the image forming apparatus 1 includes the output tray 7, the operation panel 20, a power button 23, a power source lamp 24, an external memory connector 25, and a control device 26.

As illustrated in FIG. 2, the front surface side (front side Y1) of the housing 8 covers the image former 4. In this specification, a portion (front side portion) of the housing 8 that makes up the front surface side is referred to as "housing front surface portion 9". In addition, in the housing front surface portion 9, a portion on the upper side Z1 of the midpoint in the up-down direction Z (front surface vertical midpoint M1) is referred to as "housing front surface upper portion 9a", and a portion on the lower side Z2 of the front surface vertical midpoint M1 in the up-down direction Z is referred to as "housing front surface lower portion 9b" (see FIG. 3).

As illustrated in FIG. 2, in the image forming apparatus 1, the sheet P is ejected from the ejection port 6 toward the front side Y1. Specifically, the image forming apparatus 1 performs forward discharging of the sheet P in the direction from the rear side Y2 to the front side Y1 (ejection direction B). In addition, as illustrated in FIGS. 1 and 2, in the housing 8, a discharge space S to which the sheet P is ejected is formed on the front side Y1 of the ejection port 6. As illustrated in FIG. 1, in the housing 8 of the apparatus main body 3, a sheet outlet 11 serving as an opening for removing the sheet P is formed on the front side Y1 of the discharge space S.

The ejected sheet P is placed on the output tray 7. As illustrated in FIG. 2, the output tray 7 is provided on the upper side Z1 of the image former 4. More specifically, as illustrated in FIG. 2, the discharge space S is formed on the upper side Z1 of the image former 4, and the output tray 7 is formed on the lower side Z2 of the discharge space S.

The operation panel 20 is a member separated from the apparatus main body 3, and is disposed at the sheet outlet 11 of the apparatus main body 3. More specifically, as illustrated in FIG. 2, the operation panel 20 is disposed on the upper side of the sheet outlet 11 and disposed to protrude to the front side Y1 from the sheet outlet 11.

As illustrated in FIG. 3, the operation panel 20 is provided with a touch panel 21 and a notification lamp 22. The operation panel 20 is a member composed of the touch panel 21 and the notification lamp 22 integrated with each other. As illustrated in FIG. 4, in a front view, the operation panel 20 has a substantially rectangular external appearance with a notch formed in a lower right portion.

The touch panel 21 receives an instruction to the apparatus. In the touch panel 21, which is a liquid crystal display, when various display buttons displayed on the display are touched and selected by the user, the operation is received. The touch panel 21 receives various operations related to the functions of the image forming apparatus 1, such as printing, fax transmission, and copying.

As illustrated in FIG. 4, the touch panel 21 has a size occupying the majority of the area of the operation panel 20 in a front view. More specifically, the touch panel 21 has a size in the left-right direction X (touch panel full left-right length D2) that occupies at least one half or more (1/2 or more) and 9/10 or less of the size of the operation panel 20 in the left-right direction X (operation panel full left-right length D1).

Note that in the image forming apparatus 1 of the present embodiment, the touch panel 21 has a size of 4 inches. Preferably, the touch panel full left-right length D2 of the touch panel 21 is 2/3 or more of the operation panel full left-right length D1. In addition, preferably, the touch panel 21 is 4 inches or larger. This can maximize the size of the touch panel 21 while minimizing the size of the operation panel 20.

The notification lamp 22 provides a notification of the apparatus state. More specifically, the notification lamp 22 provides a notification of the apparatus state such as whether the apparatus has been normally activated. The notification lamp 22 includes an LED as a light source. The notification lamp 22 provides a notification of various apparatus states using combinations of the emission color and the lighting mode (lighting, blinking, and off). Specifically, the notification lamp 22 is a lamp that provides a notification of various information using the lighting mode such as lighting, blinking, emission color, and the like. Note that the light emission mode of the notification lamp 22, and the notification information to be provided will be specifically described later.

Note that in this specification, a state where the lamp (the notification lamp 22 and the power source lamp 24) continuously emits light is referred to as "lighting", a state where the lamp intermittently emits light is referred to as "blinking", and a state where the lamp continuously stops light emission is referred to as "off". In addition, the mode of the lamp including the lighting, blinking, and off is referred to as "lighting mode". Further, in this specification, the mode using the combination of the emission colors and/or the lighting modes of the lamp is referred to as "light emission mode".

As illustrated in FIG. 3, the notification lamp 22 has a shape whose length in the left-right direction X is greater than the length in the up-down direction Z. Specifically, the notification lamp 22 has a laterally long shape. Note that as described later, the notification lamp 22 can emit light of two colors (blue light and orange light).

The power button 23 receives ON/OFF operations of the power source of the apparatus. The power button 23 of the present embodiment is a rocker switch that switches between ON and OFF by pressing one side of the switch, causing the opposite side to rise. This can enhance the operational feel for the user. Note that the power button 23 is not limited to the rocker switch, and may be selected from among various switches such as slide switches and push switches.

The power source lamp 24 provides a notification regarding whether the ON operation of the power button 23 is receivable. The power source lamp 24 includes an LED as a light source. In the present embodiment, the power source lamp 24 emits single-color light (in the present embodiment, blue light).

Note that although not illustrated in the drawing, the image forming apparatus 1 includes a main power source fed from a power plug, and a power source of the apparatus fed from the main power source. Feeding of the main power source is started when a power plug is inserted to the outlet. On the other hand, the power source of the apparatus, which is fed from the main power source, is fed from the main power source when the power button 23 is turned ON. In the following description, the power source of the apparatus fed from the main power source is simply referred to as "power source".

### Lighting Mode of Power Source Lamp and Notification Content

Lighting modes of the power source lamp 24 and notification contents corresponding to the light emission modes are elaborated below. The power source lamp 24 changes the lighting mode in accordance with the state after the main power source ON. More specifically, the power source lamp 24 blinks at a low luminance in the period until the power feeding to the apparatus is enabled (the period until the reception of the ON operation of the power button 23 is enabled) after the power feeding to the main power source is started (for example, after the power plug is inserted to the outlet). In addition, when the power feeding to the apparatus is enabled (when the reception of the ON operation of the power button 23 is enabled), the power source lamp 24 stops blinking and performs lighting (lighting at a low luminance). Specifically, during the period immediately after the main power source ON, the power source lamp 24 performs blinking, and when the reception of the ON operation of the power button 23 is enabled, the power source lamp 24 performs lighting at a low luminance and maintains the lighting at a low luminance until the power button 23 is turned ON. Further, after the power source is turned ON, the power source lamp 24 performs lighting at a high luminance.

Note that in some situations, the power source lamp 24 may emit light in a different lighting mode, such as lowering the luminance (lowering the illuminance) and blinking, after the reception of the ON operation of the power button 23 is enabled. For example, when the power source is OFF while the power feeding to the main power source is continued, the power source lamp 24 performs lighting at a lowered luminance. In addition, when receiving print data, the power source lamp 24 blinks rapidly with blue light at a high luminance. Further, in the power-saving mode, the power source lamp 24 blinks slowly with blue light at a high luminance. Note that when reception of print data and the power-saving mode simultaneously occur, the power source lamp 24 gives priority to rapid blinking with blue light.

In this manner, when the power feeding to the main power source is performed but the power feeding to the apparatus is insufficient, the power source lamp 24 blinks, whereas when the power feeding to the apparatus is sufficient and the ON operation of the power button 23 is receivable, the power source lamp 24 performs lighting. On the other hand, the notification lamp 22 provides a notification of the apparatus state, such as whether the state is a printable state, and occurrence of errors. Specifically, the notification lamp 22 provides a notification of the apparatus state where the power feeding to the apparatus is being performed after the ON operation of the power button 23. In this manner, the power source lamp 24 and the notification lamp 22 differ from each other in that whether they provide a notification of the state before or after the power button 23 is turned ON.

The external memory connector 25 is a connection port for connecting the connector of an external memory. In the present embodiment, the external memory connector 25 is a USB port for connecting a USB connector.

The control device 26 controls the operations of each configuration provided in the image forming apparatus 1, and the supply of power. As indicated with the broken line in FIG. 3, the control device 26 is disposed on the left side X1 inside the housing 8.

### Layout of Each Configuration

Next, with reference to FIG. 3, an arrangement (layout) of each configuration in the image forming apparatus 1 is described.

### First Embodiment

The image forming apparatus 1 of the present embodiment includes the image former 4 that forms images, the output tray 7 on which the sheet P ejected toward the front side Y1 is placed, the operation panel 20 provided on the upper side Z1 of the output tray 7, the power button 23 that receives the ON/OFF input operation of the power source of the apparatus, and the housing 8 that houses the image former 4. In addition, in the image forming apparatus 1 of the present embodiment, the operation panel 20 includes the touch panel 21 that receives the operation for the apparatus, and the notification lamp 22 that provides a notification of the apparatus state. Further, in the image forming apparatus 1 of the present embodiment, the notification lamp 22 has a laterally long shape, and is disposed along a lower-side side 21a of the touch panel 21 at a lower portion of the operation panel 20 (see FIG. 4). Further, in the image forming apparatus 1 of the present embodiment, the power button 23 is disposed at the housing front surface upper portion 9a on the upper side Z1 of the midpoint in the up-down direction Z (the front surface vertical midpoint M1) in the housing front surface portion 9 on the front surface side of the housing 8, and is provided at a position overlapping in the up-down direction Z the range of the notification lamp 22 in the left-right direction X (lamp left-right range R).

As illustrated in FIG. 3, in the image forming apparatus 1, in a front view, the power button 23 is disposed within the range occupied by the notification lamp 22 in the left-right direction X (lamp left-right range R). In other words, in the image forming apparatus 1, when the notification lamp 22 is visually recognized, the power button 23 is provided at a position immediately below the notification lamp 22. In other words, in the image forming apparatus 1, when the power button 23 is operated, the notification lamp 22 is provided at a position immediately above the power button 23.

In addition, in the image forming apparatus 1, the power button 23 is disposed at a position close to the notification lamp 22 (the vicinity of the upper end portion) in the up-down direction Z in the housing front surface upper portion 9a (the upper portion on the front surface side of the housing 8). In other words, the power button 23 is disposed on the lower side Z2 of the operation panel 20 with the output tray 7 therebetween. Note that preferably, the power button 23 is provided at a position corresponding to about one-third of the upper portion of the housing front surface portion 9 in the housing front surface portion 9. This makes it possible to place the power button 23 closer to the notification lamp 22, thereby facilitating the visual recognition of the notification lamp 22 when the power button 23 is operated.

In this manner, in the image forming apparatus 1 of the present embodiment, the power button 23 is provided at a position close to the operation panel 20 on the lower side Z2 of the operation panel 20 (the housing front surface upper portion 9a). Therefore, when the power button 23 is operated, the operation panel 20 is also within the field of view within the range of the line of sight directed toward the power button 23. According to the image forming apparatus 1 of the present embodiment, when the power button 23 is operated, the touch panel 21 and the notification lamp 22 disposed in the operation panel 20 are easily within the field of view in addition to the power button 23. Accordingly, in the image forming apparatus 1 of the present embodiment, when the power button 23 is operated (ON/OFF operation), the notification lamp 22 is within the field of view of the user, thus making it easier to confirm a reception of the operation and to determine the apparatus state.

### Second Embodiment

In the image forming apparatus 1 of the present embodiment, the length of the exposed surface of the notification lamp 22 in the left-right direction X (notification lamp full left-right length D3) is 1/2 or more of the length of the touch panel 21 in the left-right direction X (the touch panel full left-right length D2). As illustrated in FIG. 4, in the present embodiment, the notification lamp full left-right length D3 of the notification lamp 22 is 1/2 or more and 3/4 or less of the operation panel full left-right length D1.

The exposed surface of the notification lamp 22 is a portion of the notification lamp 22 exposed from the housing of the operation panel 20. Specifically, the length of the exposed surface of the notification lamp 22 in the left-right direction X means the apparent length of the notification lamp 22 in the left-right direction X.

In this manner, in the image forming apparatus 1 of the present embodiment, the notification lamp 22 appears as a relatively large lamp. Specifically, the notification lamp 22 provided in the image forming apparatus 1 is of a size that is easily noticeable to the user, unlike a small lamp provided within the operation panel 20. Therefore, according to the image forming apparatus 1 of the present embodiment, when the power button 23 is operated, the notification lamp 22 is easily noticeable to the user, thus making it easier for the user to notice the notification.

### Third Embodiment

The image forming apparatus 1 of the present embodiment includes the power source lamp 24 that provides a notification regarding whether the ON operation of the power button 23 is receivable, and the power source lamp 24 is provided on the upper side Z1 or the lower side Z2 (in the present embodiment, the upper side Z1) of the power button 23 in the housing front surface upper portion 9a. For example, the power source lamp 24 can be provided at a position adjacent to the power button 23 and immediately above the power button 23.

According to the image forming apparatus 1 of the present embodiment, when the power button 23 is operated, the power source lamp 24 is easily within the field of view of the user. Accordingly, in the image forming apparatus 1, when the power button 23 is operated, the power source lamp 24 can be visually recognized simultaneously with the power source lamp 24, thus making it possible to easily determine whether the operation of the power button 23 is receivable.

### Fourth Embodiment

In the image forming apparatus 1 of the present embodiment, the power source lamp 24 performs lighting or blinking in accordance with whether the ON operation of the power button 23 is receivable. Note that in the image forming apparatus 1 of the present embodiment, when the ON operation of the power button 23 is receivable, the power source lamp 24 performs lighting, whereas when the ON operation of the power button 23 is not receivable (when power feeding to the power source is insufficient) the power source lamp 24 performs blinking.

According to the image forming apparatus 1 of the present embodiment, when the power button 23 is operated, whether the operation is receivable can be easily determined based on whether the power source lamp 24 is lighting or blinking.

### Fifth Embodiment

The image forming apparatus 1 of the present embodiment includes the external memory connector 25 for connecting an external memory. The external memory connector 25 is provided in the housing front surface lower portion 9b on the lower side Z2 of the front surface vertical midpoint M1 in the housing front surface portion 9.

The external memory connector 25 may possibly cause connection defects or apparatus defects when contacted by the hand or body of the user in the state where an external memory is inserted. Therefore, desirably, the external memory connector 25 is provided at a position separated from the operation panel 20 and the output tray 7 as much as possible.

In the image forming apparatus 1 of the present embodiment, the external memory connector 25 is provided in the vicinity of an end portion on the lower side Z2 at a long distance from the operation panel 20 in the height direction (the up-down direction Z) of the housing front surface portion 9. In other words, the external memory connector 25 is provided near the installation surface (such as a floor surface or a desk surface) of the image forming apparatus 1 at a position less likely to be contacted by the user’s hand or body when operating the apparatus or removing the sheet P. In this manner, according to the image forming apparatus 1 of the present embodiment, it is possible to prevent the user from inadvertently touching the external memory such as a USB memory in the state where the external memory is inserted into the external memory connector 25.

### Sixth Embodiment

The image forming apparatus 1 of the present embodiment includes the touch panel 21, the notification lamp 22, the power button 23, the power source lamp 24, and the external memory connector 25. In addition, in the image forming apparatus 1 of the present embodiment, the touch panel 21, the notification lamp 22, the power button 23, and the external memory connector 25 are disposed in this order from the upper side Z1. Further, as illustrated in FIG. 3, in the image forming apparatus 1 of the present embodiment, in a front view, the touch panel 21, the notification lamp 22, the power button 23, and the external memory connector 25 are provided at positions overlapping one virtual line L extending in the up-down direction Z.

In the image forming apparatus 1 of the present embodiment, the touch panel 21, the notification lamp 22, the power source lamp 24, and the external memory connector 25 are disposed side by side on one straight line (on the virtual line L) in the up-down direction Z. In this manner, in the image forming apparatus 1, when the touch panel 21 is operated, the notification lamp 22, the power source lamp 24, and the like are easily simultaneously within the field of view of the user, thus making it possible to easily determine the apparatus state.

Now the movement of the line of sight of the user during the power ON operation is described. First, the user determines whether the ON operation of the power button 23 is receivable by visually recognizing the power source lamp 24 provided immediately above the power button 23. When the power source lamp 24 is in a lighting state, the user can determine that the ON operation of the power button 23 is receivable. After the user presses the power button 23, the user can determine whether the apparatus has been normally activated by visually recognizing the notification lamp 22 disposed on the upper side Z1 of the power source lamp 24. In this manner, the user can determine the state before and after the power source ON by moving the line of sight along the up-down direction Z before and after ON of the power button 23.

In this manner, in the image forming apparatus 1 of the present embodiment, when the user switches the power source from OFF state to ON state, the user naturally visually recognizes the operation panel 20, the power button 23, the power source lamp 24, and the external memory connector 25 disposed on one straight line by linearly moving the line of sight. Therefore, during or before pressing the button 23, the states such as the feeding state and the printable state can be easily determined, and thus the operability is improved.

In addition, in the image forming apparatus 1 of the present embodiment, the various interfaces such as the operation panel 20, the power button 23, and the external memory connector 25 are provided in the left portion or the right portion (in the image forming apparatus 1 of the present embodiment, the left portion) in the apparatus main body 3. In other words, in the image forming apparatus 1 of the present embodiment, the interfaces are disposed on the same side (left side or right side) in the left-right direction X in the apparatus, and aligned in the up-down direction Z. In this manner, in the image forming apparatus 1 of the present embodiment, during an operation on the operation panel 20, turning ON of the power button 23 and the like, the external memory connector 25 can be within the field of view, and thus the insertion state of the external memory can be confirmed. Accordingly, in the image forming apparatus 1 of the present embodiment, the insertion state of the external memory can be easily visually recognized, and forgetting to remove the external memory can be prevented.

### Seventh Embodiment

In the image forming apparatus 1 of the present embodiment, in a front view, the operation panel 20 is disposed on the left side X1 of the midpoint (apparatus left-right midpoint M2) of the apparatus main body 3 in the left-right direction X.

More specifically, the operation panel 20 is disposed near the left end of the apparatus main body 3 on the left side X1 (left side) of the midpoint of the apparatus main body 3 in the left-right direction X (apparatus left-right midpoint M2). Note that the position of the operation panel 20 is preferably a position that does not hinder the removal of the sheet P. As such, desirably, the operation panel 20 is located at the end on the left side X1 in a front view.

In a small-sized image forming apparatus, the space for disposing each configuration is limited. In addition, the majority of users are right-handed and most discharged sheets P are taken with the right hand. In the image forming apparatus 1 of the present embodiment, the operation panel 20 is disposed on the left side X1 avoiding the center in the left-right direction X so that the user can easily view the output tray 7 when operating the operation panel 20. In the image forming apparatus 1 of the present embodiment, since the operation panel 20 is disposed on the left side X1, the discharge port, which is frequently used, can be easily viewed and when the sheet P on the output tray 7 is taken with the dominant hand, the operation panel 20 does not interfere, thus making it easier to remove the sheet P even with the image forming apparatus 1 having a small width.

### Light Emission Mode and Notification Content of Notification Lamp

Next, light emission modes of the notification lamp 22, and notification contents corresponding to the light emission modes are described. As described above, the notification lamp 22 provides a notification of the apparatus states such as the printable state by means of predetermined light emission modes.

### Eighth Embodiment

In the image forming apparatus 1 of the present embodiment, the notification lamp 22 provides a notification of the apparatus state by means of a plurality of lighting modes including lighting and blinking and/or a plurality of emission colors. In addition, the notification lamp 22 emits light in different modes for providing a notification of errors and a notification of other states.

In the image forming apparatus 1 of the present embodiment, the notification lamp 22 emits light in different modes (emission color and/or lighting mode) for a normal state and an error occurrence state. In this manner, in the image forming apparatus 1, the user can easily recognize the occurrence of an error.

### Ninth Embodiment

In the image forming apparatus 1 of the present embodiment, after the ON operation of the power button 23 has been received, the notification lamp 22 emits light in a first color (in the present embodiment, blue) when the state has transitioned to the printable state that enables printing, whereas the notification lamp 22 emits light in a second color (in the present embodiment, orange) different from the first color when the state cannot be transitioned to the printable state.

In the image forming apparatus 1 of the present embodiment, the notification lamp 22 emits light in different colors depending on whether the state has transitioned to the printable state. As a result, in the image forming apparatus 1, the user can easily determine whether the state is the printable state.

The notification modes of the notification lamp 22 are described below in more detail. In the image forming apparatus 1 of the present embodiment, the notification lamp 22 can emit blue light and orange light. Specifically, the notification lamp 22 can execute a light emission mode of emitting blue light and a light emission mode of emitting orange light. In addition, the notification lamp 22 can execute a plurality of lighting modes including lighting, blinking, and off. Specifically, the notification lamp 22 can perform a plurality of types of light emission modes using combinations of lighting modes and emission colors. Light emission modes that can be executed by the notification lamp 22, and notification contents of the light emission modes are described below.

### 1. Lighting with Blue Light

In the state where the apparatus is operating normally and printing is enabled (printable state), the notification lamp 22 performs lighting with blue light. More specifically, in a printable state (except during the power-saving mode), a state during printing, and a state where a document is set in the document feeding device 2, the notification lamp 22 performs lighting with blue light. In other words, by the lighting with blue light, the notification lamp 22 provides a notification of a printable state (except during the power-saving mode), a state during printing, and a state where a document is set in the document feeding device 2.

### 2. Blinking with Blue Light

During FAX reception, the notification lamp 22 performs blinking with blue light. In other words, by the blinking with blue light, the notification lamp 22 provides a notification that FAX reception is in progress.

### 3. Lighting with Orange Light

In an error occurrence state where the operation is executable, the notification lamp 22 performs lighting with orange light. Examples of the errors where the operation is executable include a state where the remaining amount of toner is equal to or less than a predetermined amount (toner near end). The notification lamp 22 provides a notification of toner near end by the lighting with orange light.

### 4. Blinking with Orange Light

In an error occurrence state where the operation cannot be executed, the notification lamp 22 performs blinking with orange light. Examples of the errors where the operation cannot be executed include a printing disabled state, insufficient toner remaining amount (toner end), paper jam, and discharge sheet full. By the blinking with orange light, the notification lamp 22 provides a notification of the printing disabled state, toner end, paper jam, and discharge sheet full.

### 5. Turning Off

In cases other than the above-mentioned cases, the notification lamp 22 turns off. For example, in a state during the power-saving mode and a state where the power source is OFF, the notification lamp 22 turns off.

In this manner, in a state with no error (normal state), the notification lamp 22 provides a notification with blue light. On the other hand, when an error has occurred, the notification lamp 22 provides a notification with orange light.

### Tenth Embodiment

In the image forming apparatus 1 of the present embodiment, the operation panel 20 does not include a hardware key.

According to the image forming apparatus 1 of the present embodiment, it is possible to achieve easy operability and size reduction by ensuring the size of the touch panel 21 disposed in the operation panel 20 and achieving a simple configuration while reducing the size of the operation panel 20.

While the embodiments of the image forming apparatus of the present disclosure are described above, the image forming apparatus of the present disclosure is not limited to the above-described embodiments.

For example, in the above-described image forming apparatus, the notification lamp emits blue light and orange light, but the notification lamp may emit light in other colors. In addition, the power source lamp is not limited to light emission in blue light, and may emit light in other colors.

The present disclosure is not limited to the embodiments described above and can be implemented in various other forms. Therefore, the embodiments are merely illustrative in all respects and should not be construed in a limiting sense. The scope of the present disclosure is indicated by the claims, and is not restricted by the description in the specification. Furthermore, all modifications and alterations falling within the equivalent scope of the claims are included within the scope of the present disclosure.

1. An image forming apparatus comprising:
an image former that forms an image;
an output tray on which a sheet ejected toward a front side is placed;
an operation panel provided above the output tray;
a power button that receives an inputting operation of turning ON/OFF of a power source of the apparatus; and
a housing that houses the image former, wherein
the operation panel includes:
a touch panel that receives an operation for the apparatus, and
a notification lamp that provides a notification of a state of the apparatus,
the notification lamp has a laterally long shape, and is disposed along a lower-side side of the touch panel at a lower portion of the operation panel, and
the power button is disposed in a housing front surface upper portion at a position overlapping in an up-down direction a range of the notification lamp in a left-right direction, the housing front surface upper portion being located on an upper side of a midpoint in the up-down direction in a housing front surface portion located on a front surface side of the housing.

2. The image forming apparatus according to claim 1, wherein a length of an exposed surface of the notification lamp in the left-right direction is 1/2 or more of a length of the touch panel in the left-right direction.

3. The image forming apparatus according to claim 1, further comprising a power source lamp that provides a notification of whether an ON operation of the power button is receivable, whereinthe power source lamp is provided on an upper side or a lower side of the power button in the housing front surface upper portion.

4. The image forming apparatus according to claim 3, wherein the power source lamp performs lighting or blinking in accordance with whether the ON operation of the power button is receivable.

5. The image forming apparatus according to claim 1, further comprising an external memory connector to which an external memory is connected, wherein the external memory connector is provided in a housing front surface lower portion located on a lower side of a vertical midpoint of the front surface in the housing front surface portion.

6. The image forming apparatus according to claim 1, further comprising: a power source lamp that provides a notification of whether an ON operation of the power button is receivable; and an external memory connector to which an external memory is connected, wherein from the upper side, the touch panel, the notification lamp, the power button, and the external memory connector are disposed in this order, and in a front view, the touch panel, the notification lamp, the power button, and the external memory connector are provided at positions overlapping one virtual line extending in the up-down direction.

7. The image forming apparatus according to claim 1, wherein in a front view, the operation panel is disposed on a left side of a midpoint of an apparatus main body in the left-right direction.

8. The image forming apparatus according to claim 1, wherein the notification lamp provides a notification of the state of the apparatus by a plurality of lighting modes including lighting and blinking and/or by a plurality of emission colors, and the notification lamp emits light in different modes depending on whether the notification lamp provides a notification of an error or a notification of another state.

9. The image forming apparatus according to claim 8, wherein after the ON operation of the power button is received, the notification lamp emits light in a first color when a state is transitioned to a printable state that enables printing, whereas the notification lamp emits light in a second color different from the first color when the state cannot be transitioned to the printable state.

10. The image forming apparatus according to claim 1, wherein the operation panel does not include a hardware key.
